(19) United States
(12) Patent Application Publication
(10) Pub. No.: US 2006/0037330 A1
(43) Pub. Date: Feb. 23, 2006

(54) Apparatus and method for the disinfection of an air conditioning installation of a stationary air conditioning system for buildings

(76) Inventor: Adolf Weigl, Englewood, FL (US)

Correspondence Address: STAAS & HALSEY LLP, SUITE 700, 1201 NEW YORK AVENUE, N.W., WASHINGTON, DC, 20005, US

(21) Appl. No.: 10/759,534

(22) Filed: Jan. 20, 2004

(30) Foreign Application Priority Data
Aug. 18, 2003 (WO) PCT/DE03/02757

(51) Int. Cl. F24F 3/16; F25D 17/00; A23L 3/36

(52) U.S. Cl. 62/78; 62/177; 62/303

(57) ABSTRACT

An apparatus for the disinfection of an air conditioning installation of stationary air conditioning system for a building or a room has an injection device (3, 11, 14) for the accurate ejection of a defined quantity of an antibacterial active substance onto an evaporator (1) of the air conditioning installation. The apparatus comprises, furthermore, a control device (18, 19) for controlling the ejection times of the injection device in the automated repetition mode.

The invention relates to an apparatus and a method for the disinfection of an air conditioning installation of a stationary air conditioning system.

A large proportion of rooms used by people is nowadays air-conditioned. For air conditioning, air conditioning installations are employed, which, to lower the room temperature, have an evaporator, by means of which an air stream flowing through the air conditioning installation is cooled. Air conditioning installations of this type are known in the most diverse possible sizes. As stationary central installations of branched air conditioning systems, they are employed for the air conditioning of buildings or large room units, such as, for example, supermarkets, banks, hairdressing salons, restaurants, hospitals, discotheques, residential buildings and the like.

A serious problem of air conditioning installations of this type is that the evaporator, through which the air stream to be cooled is led, in time becomes clogged. The user notices this, as a rule, from the fact that the operating intervals of the air conditioning installation become longer, since the cooling capacity of the installation decreases. The main cause of the clogging of the lamellae of the evaporator and consequently of the loss of capacity of the installation is spores, bacteria or other microorganisms which in time form between the lamellae and, together with deposits, significantly reduce the effective flow cross section of the evaporator.

This heavy organic contamination of the evaporator is based on moisture which is caused by the formation of condensation water on the cool evaporator lamellae and which constitutes an optimum nutrient medium for the growth of microorganisms.

The contamination of the evaporator by spores, bacteria and other microorganisms not only leads to the loss of capacity of the installation, but also to further serious disadvantages: a first disadvantage is that the evaporator contaminated in this way itself acts as a pollutant emitter, that is to say enriches the air-conditioned air stream with spores, bacteria and other microorganisms. A second disadvantage is that, as a result of organic contamination, the air conditioning installation generates a characteristic odor which is felt to have a disturbing effect.

The conventional procedure for eliminating these disadvantages is to clean the air conditioning installation from time to time. During cleaning, the lamellae of the evaporator are freed of the deposits mechanically and subsequently treated with an antibacterial agent. One disadvantage is that this procedure is time-consuming and cost-intensive and has to be repeated at regular time intervals. Furthermore, the installation has to be switched off during the cleaning work and for a specific period of time after the conclusion of the cleaning work (because of reaction and vaporization of the toxic antibacterial agent.

A system for cleaning an evaporator in a motor vehicle air conditioning installation is known from the publication U.S. Pat. No. 6,065,301. A cleaning fluid is sprayed onto the evaporator via a nozzle rod 1 arranged in the flow path. Spraying is carried out manually by depressing a container in which the cleaning fluid is located. Regular cleaning of the system is not ensured because of the handling which is manual.

The publication U.S. Pat. No. 5,957,771 relates to an aroma display mechanism which is integrated into an air conditioning installation and which is implemented by means of a solenoid valve. This publication does not disclose a use of antibacterial cleaning substances.

Since the spray head mounted on the active substance container and also the pumping mechanism are arranged decentrally in spatial terms, it is not possible to spray the evaporator accurately and with good distribution in terms of quantity.

The publication U.S. Pat. No. 5,302,359 describes an apparatus for generating a deodorized air stream in an air conditioning system. An aromatic fluid is applied by means of an electric pump to an absorbent material which is located in a trough within the air duct of the air conditioning installation. The absorbent material successively discharges the odorous substance into the air stream.

The object on which the invention is based is to provide an apparatus and a method for improving the air in rooms, which are respectively to prevent, as far as possible, the occurrence of unpleasant odors in air-conditioned rooms of a building. In particular, a deposition of organic pollutants on the lamellae of the evaporator of the air conditioning installation is to be prevented effectively and in a long-lasting way.

The subject on which the invention is based is achieved by means of the features of the independent claims. Advantageous developments on and refinements of the invention are the subject matter of the subclaims.

According to claim 1, the apparatus according to the invention for the disinfection of an air conditioning installation of a stationary air conditioning system of a building or a room comprises an electromechanical injection device for the accurate injection of a defined quantity of an antibacterial active substance onto an evaporator of the air conditioning installation, and a control device for controlling the ejection times of the injection device in the automated repetition mode.

The invention is based on the recognition that, in air conditioning systems of buildings, it is possible to prevent the formation of microorganisms on an evaporator of an air conditioning installation by spraying the evaporator of an air conditioning installation with an antibacterial active substance virtually continuously, that is to say, for example, with multiple repetition throughout the day, in so far as very small quantities of the active substance per “cleaning shot” are applied to the evaporator. Otherwise, the load on the evaporator caused by the (toxic) antibacterial active substance would be too great. Furthermore, in the tests conducted within the scope of the invention, it was found that the small quantity of the antibacterial active substance must be applied to the evaporator with high accuracy, so that it can be ensured that, during each injection operation, always the same (if possible, entire) evaporator surface is uniformly wetted at a low level. The control device for controlling the ejection times, which operates in the repetition mode, ensures cleaning without actions by the user.

Preferably, the injection device according to the invention has a reservoir for storing the antibacterial active substance, an injection pump activated electrically by the control device, and at least one nozzle head connected to an outlet of the injection pump via a pipeline. What is achieved by the pipeline between the injection pump and the nozzle head is that the nozzle head can be placed in an optimum position for wetting the evaporator over the entire surface of the latter.

The ejection of the active substance volume must take place with a pressure which builds up quickly and is sufficiently high, so that an always accurate and uniform wetting of the evaporator can be ensured. In this respect, a first, particularly preferred embodiment of the invention is characterized in that the injection pump comprises a compressible volume filled with active substance and an actuating mechanism for the abrupt compression of the volume. By the fluid-filled volume being acted upon directly, the necessary ejection pressures can readily be achieved owing to the incompressibility of the active substance fluid.

A further aspect important for the quality of functioning of the apparatus is that the ejected active substance should not contain any air. The injection system must operate free of air. Otherwise, the ejected active substance volume would be so light that it would be deflected by the air stream in the air conditioning installation (said air stream, as a rule, not being oriented parallel to the direction of ejection of the active substance) and could no longer be applied accurately to the evaporator. By the fluid-filled volume being acted upon directly, as already mentioned, in order to pump the active substance, such a pumping system operating free of air is implemented.

A further advantageous measure is characterized in that a nonreturn valve is arranged between the outlet of the injection pump and the nozzle head. The nonreturn valve prevents fluid located in the pipeline from running back into the injection pump, whilst eliminating the risk of the formation of air bubbles in the pipeline. Furthermore, the nonreturn valve also prevents the active substance fluid from possibly dripping out of the nozzle head.

A second advantageous embodiment of the apparatus according to the invention is characterized in that the nonreturn valve is provided with a prestressing means which has the effect that an opening of the valve in the throughflow direction takes place only when the prestress is exceeded. In this case, even a pump with a slow start-up behavior, for example a rotary pump may be used. A rapid pressure build-up in the ejection phase is ensured by the opening delay caused by the prestressing means.

The definability of the active substance quantity ejected during each “active substance shot” and a high ejection pressure can ensure the functioning capacity of the installation in a virtually continuous long-term operation (that is to say, in the case of a plurality of daily dosages of active substance).

Preferably, the nozzle head is mounted on the pipeline in an articulated manner. This allows an exact adjustability of the nozzle head with respect to its spraying direction. An accurate spraying of the evaporator can thereby be brought about even in different mounting situations.

Preferably, the control device allows a variable setting of the ejection times of the injection device. By the ejection frequency being varied, the apparatus according to the invention can be adapted to different sizes of air conditioning systems.

In this case, an advantageous exemplary embodiment of the invention is characterized in that the control device of the injection device is connected to a control unit of the air conditioning system. In the simplest form, the control device of the injection device is activated and deactivated according to the on/off operating state of the air conditioning system, for example in that the control device of the injection device is supplied by the switched operating voltage of the air conditioning installation of the air conditioning system. What is achieved thereby is that the injection device is operative and dispenses the antibacterial active substance only when the air conditioning installation is running. On the other hand, by the air conditioning installation being switched off, the injection device, too, is switched off. This consequently prevents a consumption of active substance from occurring when the air conditioning installation is switched off (for example, in business rooms at the weekend).

Furthermore, the control device of the injection device can be controlled as a function of the operating state of the air conditioning installation. For example, the control of the injection device as a function of the air throughput (fan power) of the air conditioning installation or of other operating parameters, such as, for example, a cooling of the air in the air conditioning installation, is possible. An exact coordination of the frequency of dosages of active substance with the basic operating parameters can thus be achieved for virtually all situations and conditions.

A further advantageous refinement of the invention is characterized in that the control device comprises an electric motor, a rotatable control disk driven by the electric motor and at least one electrical switch which can be actuated by means of one or more actuating members attached to the control disk and which is provided for switching a current for the injection pump of the injection device. By the time control of the “active substance shots” via an electric motor with a control disk, a mechanically simple and low-maintenance control device is implemented.

According to a particularly advantageous aspect of the invention, an active substance concentrate may be used as active substance fluid. The use of an active substance concentrate makes it possible to have a small overall size of the apparatus according to the invention or longer change time intervals for the exchange of the active substance container (reservoir). The use of an active substance concentrate is made possible for the first time by the invention, since, owing to the toxicity of the concentrate, exact quantity controllability and an accurate application of the active substance to the evaporator are indispensable for safety reasons in the case of an apparatus operating in the intermittent continuous mode. A further advantageous refinement of the invention is characterized in that the apparatus has a plurality of nozzle heads which are fed by the common injection pump via respective pipelines. Such a solution makes it possible to keep clean continuously evaporator systems which either have an evaporator with large dimensioning or are constructed from a plurality of individual evaporator elements.

In addition to the injection device, the apparatus according to the invention may advantageously comprise, furthermore, a metering device for the time-controllable dispensing of an aromatic substance and an absorbent uptake carrier which is provided in a duct of the air conditioning system and onto which the aromatic substance dispensed by the metering device is metered. The addition of a fragrant aromatic substance into the air stream flowing through the air conditioning system is implemented by means of the metering device and the absorbent uptake carrier. The absorbent uptake carrier in this case has the effect that the active substance dispensed by the metering device is not added to the air stream in the air conditioning system abruptly, but over a specific period of time. By means of the metering device, a desired degree of saturation of the uptake carrier can be set and maintained. A continuous enrichment of the air stream with the aromatic substance can thereby be achieved. Nevertheless, because of the metering device, the apparatus has a good variability, controllable over a wide range, in the admixing of the active substance, so that the most diverse possible conditions (small rooms or large-volume buildings, operation of the air conditioning system in the cooling or the heating mode) can be taken into account.

In such a combination installation (dispensing of antibacterial active substance and aromatic substance), an advantageous refinement of the invention is characterized in that the control device is provided both for controlling the injection device for injecting the antibacterial active substance and for the time control of the metering device for metering the aromatic substance onto the absorbent uptake carrier.

In this way, by means of one and the same control device, both the metering frequency and/or metering quantity for dispensing the aromatic substance and the frequency and/or the injection quantity for ejecting the antibacterial active substance by means of the injection system according to the invention can be controlled. It is important, in this case, that the antibacterial active substance and the aromatic substance can be controlled independently of one another in terms of quantity.

Preferably, the absorbent uptake carrier consists of a fiber-containing and/or open-pore material, in particular cellulose or an absorbent paper. These materials make it possible, on the one hand, to have a good lateral distribution of the aromatic substance in the uptake carrier and consequently provide an evaporation surface of sufficient size. On the other hand, these materials exhibit, for the aromatic substance, a storage behavior which has the effect that, even in the case of an aromatic substance metering which is discrete in time, a dispensing, essentially uniform over time, of the aromatic substance to the air stream is achieved.

Preferably, the control device of the apparatus according to the invention comprises a remote monitoring and/or remote operating device, by means of which the apparatus can be monitored and/or operated by the user. In particular, the remote monitoring and/or remote operating device may be a monitoring and/or remote operating panel which is removable from the apparatus and which is connected to the apparatus according to the invention via a radio or line interface. Particularly in residential units and relatively small houses, the air conditioning systems (air conditioning installations) are often installed in inaccessible locations, for example in a boxroom or in the attic area. In this case, the remote monitoring and/or remote operating device makes it possible to detect functional states of the apparatus according to the invention (for example, the storage container for the antibacterial active substance or the aromatic substance is empty), without a regular check of the apparatus according to the invention having to be carried out on the spot for this purpose.

The invention is explained in more detail below by means of examples, with reference to the drawings in which:

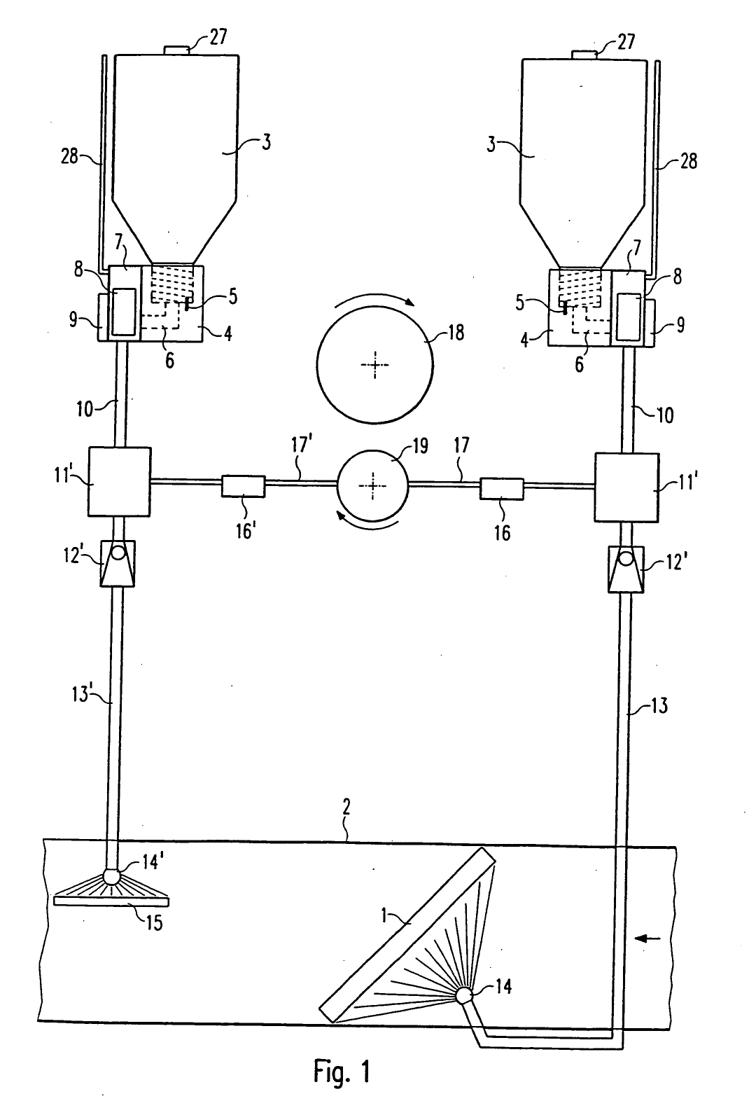

FIG. 1 shows a diagrammatic illustration of an apparatus according to the invention for improving the air for a stationary air conditioning system of a building, which system comprises a device for applying an antibacterial active substance to an evaporator of an air conditioning installation of the air conditioning system and a device for the admixing of aromatic substances;

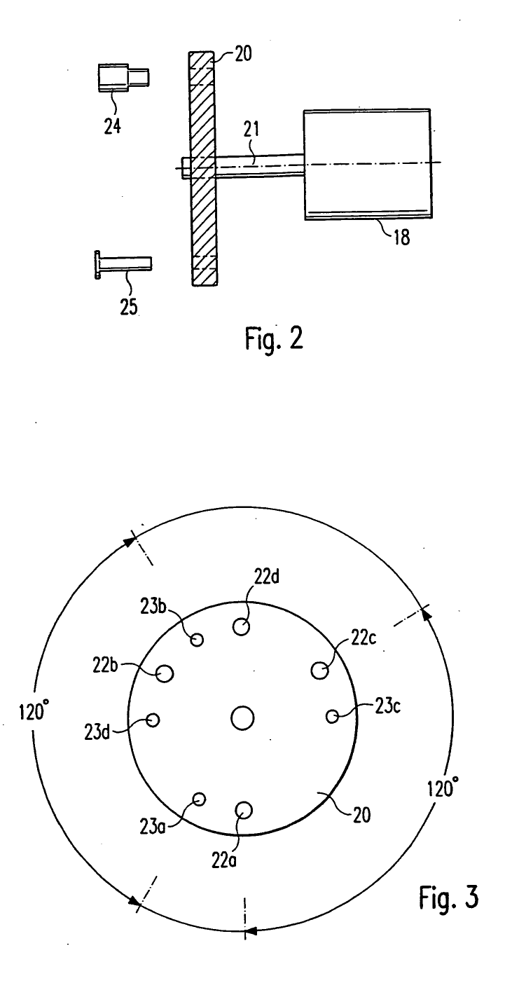

FIG. 2 shows a side view of an electric motor with a control disk for controlling the apparatus illustrated in FIG. 1;

FIG. 3 shows a top view of the control disk shown in FIG. 2;

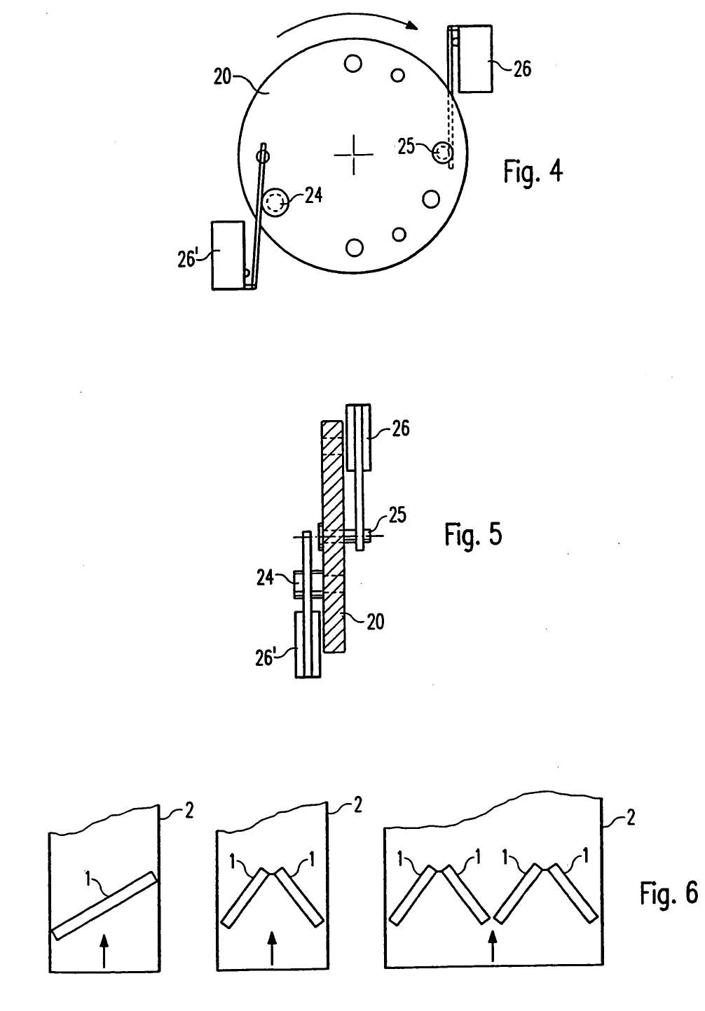

FIG. 4 shows a top view of an arrangement consisting of two electrical switches and of the control disk shown in FIGS. 2 and 3;

FIG. 5 shows a partial sectional illustration of the arrangement shown in FIG. 4;

FIG. 6 shows three different variants of the arrangement of one or more evaporators within a central duct of an air conditioning system;

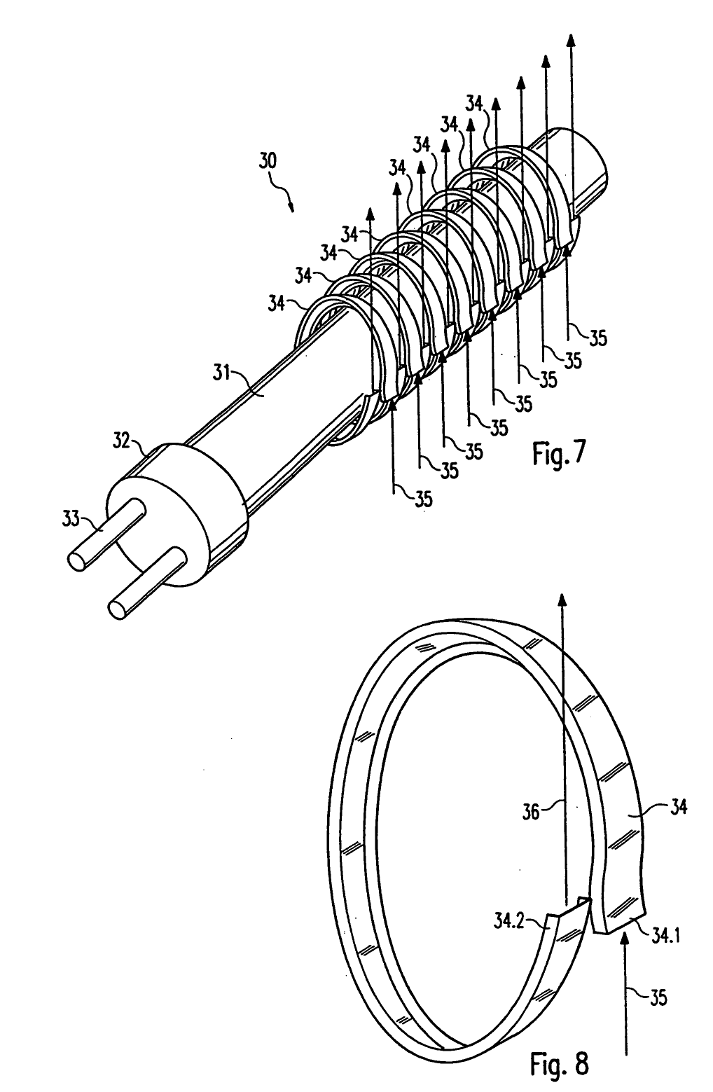

FIG. 7 shows a perspective illustration of a UV lamp for irradiating an air stream; and

FIG. 8 shows a perspective illustration of a circumferential duct of the UV lamp illustrated in FIG. 7.

FIG. 1 shows a diagrammatic illustration of an exemplary embodiment of the air improvement apparatus according to the invention for buildings or houses. The air conditioning of buildings or houses takes place via stationary air conditioning installations which are integrated in an air conditioning system of the building. Air is drawn off a room or a plurality of rooms either near the floor or through shafts in the ceiling region and is delivered to the central air conditioning installation via a duct system. The air conditioning installation comprises a cold-air assembly (evaporator), usually also a heating system and one or more vane wheels for transporting the air flowing through the air conditioning installation. The air stream discharged from the air conditioning installation passes first into a central duct which branches, further along the flow path, into a duct system consisting of a plurality of individual ducts. Depending on the structural conditions of the house or building to be air-conditioned, the duct system is executed and designed in such a way that effective air conditioning becomes possible in the entire room or building.

The evaporator of such a stationary air conditioning installation is constructed from one or more heat exchanger plates 1. FIG. 1 illustrates a version in which a heat exchanger plate 1 is arranged in a passage duct 2 within the air conditioning installation. The direction of the air flowing through the air conditioning installation is indicated by an arrow. The vane wheel of the air conditioning installation may be located upstream or downstream of the heat exchanger plate 1 in the direction of flow and is not illustrated in FIG. 1.

The heat exchanger plate 1 is normally oriented at an inclination with respect to the direction of flow. It consists of a tube coil which is surrounded by a lamellar body and through which the refrigerant is led. The tube coil cools the lamellae of the lamellar body. On account of their large surface and the small distance between them, the lamellae have an effect of an efficient cooling of the air flowing through.

Due to the growth of germs which has already been mentioned, a felting of the lamellar body occurs within a relatively short time, and as result of this the cooling capacity is impaired and the flow resistance in the passage duct 2 is increased. In addition, the organic impurities are partially discharged to the air stream and thus lead to a contamination of the cooled air, introduced into the air-conditioned rooms, with harmful germs, bacteria, spores or other microorganisms.

The apparatus according to the invention affords a remedy in this respect. It comprises a first storage container 3 which is filled with an antibacterial fluid. The first storage container 3 has, in its outlet region, a thread, by means of which it can be screwed, head first, into a threaded receptacle which is formed in a carrier 4 for the storage container. By means of a metal spike 5, the first storage container 3 is opened when it is screwed into the threaded receptacle. The antibacterial fluid can thereby pass via an outlet line 6 into a float chamber 7 attached to the carrier 4.

A float 8 is located within the float chamber 7. Mounted outside the float chamber 7 is a noncontact switch 9 which monitors the position of the float 8 in the float chamber 7. As long as the float 8 is in an upper position in the float chamber 7, the switch causes a green LED to light up on an operating unit (not illustrated) of the apparatus according to the invention, which means that there is sufficient fluid in the first storage container 3. As soon as the float 8 sinks to the bottom of the float chamber 7 due to a lack of fluid flowing in, the switching state of the switch 9 changes. The effect of this is that, on the operating panel (not illustrated), a red LED lights up, which interrupts the supply of current to the pump (described in more detail below) of the apparatus, and an acoustic warning sound requires the user to exchange the empty storage container 3. The noncontact switch 14 may be implemented, for example, as a magnetic switch, in which case the float 8 is fitted with a permanent magnet.

To vent the supply system, the first storage container 3 is equipped with a venting valve 27 arranged on the bottom side and the float chamber 7 is equipped with a venting pipe 28.

The fluid passes from the float chamber 7 to a pump 11 via a connecting pipe 10 mounted on the bottom side. On the outlet side of the pump 11 is provided a directional valve or nonreturn valve 12 which prevents fluid located downstream of the pump in the pumping direction from being capable of flowing back into the pump 11. The outlet of the directional valve 12 is connected, via a connecting pipe 13, flexible if appropriate, to a spray head 14 arranged in the passage duct 2 of the air conditioning installation. For this purpose, the connecting pipe 13 is introduced into the passage duct 2 at a suitable point.

Depending on the form of construction of the air conditioning installation, the spray head 14 is located at a distance of about 30 to 40 cm from the heat exchanger plate 1. Preferably, said spray head is arranged in the region of the central axis of the heat exchanger plate 1, so that a uniform and full-surface spraying of the heat exchanger plate 1 with antibacterial fluid is possible. The spray exit angle may amount to about 90°, and a rotationally symmetrical spray exit cone can be implemented. In so far as the air conditioning installation has a plurality of heat exchanger plates 1 or the heat exchanger plate 1 has such large dimensioning that full-surface spraying by means of a single spray head 14 is no longer possible, a plurality of spray heads 14 may be implemented in the air conditioning installation and be connected to the dispenser system downstream of the directional valve 12 by means of a branch (not illustrated).

To introduce an aromatic scented substance into the air stream, a second dispenser system is used. This may be designed, as illustrated in FIG. 1, in a technically comparable way to the first dispenser system supplying the antibacterial active substance. As regards the second dispenser system, the same parts as in the first dispenser system are given the same reference symbols. With regard to the configuration and functioning of the second dispensing system, reference is made to the statements relating to the first dispenser system. A difference between the first and second dispenser system occurs only at the end regions of the dispenser systems on account of different requirements as to the dispensing of the respective fluids within the air conditioning installation.

Located at the end of the connecting pipe 13′ of the second dispenser system for the addition of aromatic fluid is located a spray head 14′ which is arranged centrally and vertically above an absorbent uptake carrier 15. The absorbent uptake carrier 15 is located downstream of the heat exchanger plate 1, so that no aromatic fluid can pass onto the heat exchanger plate 1 and possibly contaminate the latter. As is evident in FIG. 1, the uptake carrier 15 is located in the air stream, so that the active substance metered via the spray head 14′ vaporizes in the air stream and is transported away. The spray exit angle of the spray head 14′ may amount to about 60°, and its distance from the uptake carrier 15 amounts to a few centimeters.

The two dispenser systems must be in a position to be capable of exactly defining or setting the active substance quantity discharged (periodically or in a pulsed manner). For the second dispenser system, an adjustability of the metering quantity is important, so that a defined, desired degree of enrichment of the air flowing past with the aromatic substance can be achieved, and, for example, the risk of odor impairment (too high a degree of enrichment) or of the overflow of the uptake carrier 15 can be ruled out. For the first dispenser system (for dispensing the antibacterial active substance), quantity controllability is likewise important, since, because of the toxicity of the antibacterial active substance, the discharge of too great a quantity of active substance may be hazardous to the health of persons. It is desirable to have an application “in shots” (for example, 3-4 times a day) of a relatively small, uniformly distributed active substance quantity to the heat exchanger plate 1, said quantity being just such that the formation of microorganisms on the lamellae of the heat exchanger plate is thereby forestalled in a preventative manner.

The aromatic substance may be applied to the uptake carrier 15 in a pressureless manner or else under pressure, for example in exactly the same way as the antibacterial fluid. In contrast to this, during each “active substance shot”, the antibacterial fluid must be ejected from the spray head 14 under high pressure and sprayed onto the heat exchanger plate 1. The high pressure is required in order to ensure that, in spite of the air stream in the passage duct 2, the flow velocity of which may vary, always essentially the same region of the heat exchanger plate 1 is sprayed. It is pointed out that, because of the inclined orientation of the heat exchanger plate 1, the spraying direction is usually oriented obliquely to the direction of the air stream. If the pressure of the ejected fluid is too low, the air stream entrains the sprayed-out active substance agent, so that the latter no longer strikes the heat exchanger plate 1 over its full surface and with uniform distribution. The same would happen if air were contained in the ejected active substance fluid. In this case, the ejected volume would be too light and would likewise no longer be capable of ensuring a full-surface and uniform wetting of the heat exchanger plate 1.

To that extent, the first dispenser system must fulfill special requirements. A first possibility according to the invention is to use a diaphragm pump as pump 11. The diaphragm pump consists of a small fluid-filled container, for example in the form of a cube, one container wall of which consists of an elastic material, for example neoprene. The inlet and outlet of the pumping container are provided with nonreturn valves. An electrically controlled actuating mechanism is arranged opposite the elastic container wall. This may be, for example, an electromagnet with a translational push rod. When the electromagnet is activated, the push rod pushes against the elastic container wall in fractions of a second and compresses the container volume. As a result, the active substance fluid contained in the container is pressed out of the container with high pressure. The volume per “fluid shot” can be set by means of a suitable dimensioning of the container volume and of the travel of the push rod.

A second possibility for implementing the abrupt pressure build-up required for the ejection of the fluid volume is to implement the directional valve 12 as a pressure control valve which opens only in the event of a defined dynamic pressure and closes immediately when the fluid pressure falls below the dynamic pressure. In this case, the pump 11 may be designed in the form of a conventional rotary pump, as is used, for example, in motor vehicles for the windshield washing system. The pump 11 is activated by a time switch 16 which may be designed as a delay relay. By means of the time switch 16, the running time of the pump 11 can be set variably. When an ejection of active substance is to take place, the time switch 16 is activated by a control line 17 and thereupon supplies the pump 11 with an operating current for the preset period of time. During the starting of the pump 11, a dynamic pressure builds up in the pump casing and upstream of the nonreturn valve 12 in the feed line. As soon as the dynamic pressure overcomes the keeping-shut force of the nonreturn valve 12, the valve 12 opens abruptly, with the result that the fluid passes under high pressure to the spray head 14 and is ejected there. The delivery of the pump 11 must be sufficiently high to ensure that during the following time, upstream of the nonreturn valve 12, there is no pressure drop which would have the effect of closing the nonreturn valve 12. When this condition is fulfilled, the dispensed fluid quantity is defined by the running time of the pump 11, said running time being predetermined at the time switch 16. When the predetermined period of time has elapsed, the pump 11 is switched off. The nonreturn valve 12 closes within the rundown phase of the pump 11 and prevents fluid from being conducted under low pressure to the spray head 14 during the rundown phase of the pump.

The keeping-shut force of the nonreturn valve 12 may be of the order of magnitude of one or more N and amount, for example, to 2 N. The switching duration of the time switch 16 determines the fluid quantity per active substance shot and can amount, for example, to between 0.5 second and 2.0 seconds. In both pump versions (diaphragm pump and rotary pump), a fluid volume of between 1 and 1.5 ccm per fluid shot is typically ejected. The advantage of the second pump design variant (rotary pump) is that the feed volume expelled per fluid shot can be set within a wider range. This improves the adaptability of the installation to the different sizes of air conditioning installations, particularly when a plurality of spray heads 14 are used.

As already mentioned, the dispenser system for the aromatic substance may be designed largely identically to the dispenser system for the antibacterial fluid. A nonreturn valve 12 with a defined triggering force is not required when the aromatic substance can be metered onto the uptake carrier 15 in a pressureless manner.

The nonreturn valve 12′ can therefore be designed in a simpler way than the nonreturn valve 12.

A time sheet 16′ is likewise used in order to activate the pump 11′ in the dispenser system for the aromatic substance. The dispensed aromatic substance quantity can be set independently of the quantity of dispensed antibacterial active substance at the time switch 16′.

The triggering of the time switch 16′ via the control line 17′ is independent of the triggering of the time switch 16 via the control line 17. Although, in general, a diaphragm pump may also be used as the pump 11′, the use of a rotary pump 11 in the second dispenser system is preferred.

A control device for predetermining the times at which the two dispenser systems dispense fluid is described below by way of example with reference to FIGS. 1 to 5. The control device comprises a synchronous motor 18 which, for example, executes one axial revolution per hour. The synchronous motor 18 actuates a rotary switch 19 which makes available the switching outputs 17, 17′ for the two time switches 16, 16′. The rotary switch 19 is illustrated in more detail in FIGS. 2 to 5. It comprises a control disk 20 which is driven by a shaft 21 of the synchronous motor 18. Four bores 22a, 22b, 22c and 22d of a first diameter and four bores 23a, 23b, 23c, 23d of a second diameter different from this are arranged over the circumference of the control disk 20. The bores 22a, 22b, 22c and 23a, 23b and 23c are in each case oriented at an angle of 120° to one another. The bore 22d is arranged axially opposite (180°) to the bore 22a, the same applying to the bore 23d with respect to the bore 23c.

Pegs 24 and 25 with different peg diameters can be plugged into the bores. While the peg 25 can be plugged virtually over its entire length through a bore 23a-d, the peg 24 has a stop, the effect of which is that the peg 24 can be pressed into the bores 22a-d only as far as the stop.

As illustrated in FIGS. 4 and 5, two quick-action switches 26, 26′ with spring arms are mounted in the region of the disk circumference and can be triggered by the pegs 24, 25 running past. As can be seen in FIG. 5, the two quick-action switches 26, 26′ are arranged on different sides of the control disk 20. What is achieved thereby is that one quick-action switch 26 is triggered solely by the pegs 25, while the other quick-action switch 26′ can be triggered solely by the pegs 24. Triggering takes place in that the spring arm of the quick-action switch 26′, 26 is pressed down by the respective peg 24 or 25 as a result of the rotation of the control disk 20. While the switch output of one quick-action switch 26 is connected to the timer 16 for the first dispenser system, the switch output of the second quick-action switch 26′ is connected to the input of the second timer 16′ for the second dispenser system.

If, for example, it is desired that the antibacterial active substance is ejected once per axial revolution of the synchronous motor 18, a peg 25 is plugged into the hole 23c. If a twofold ejection of active substance is desired per axial revolution, a further peg 25 is plugged into the hole 23d. In this case, the ejection of active substance takes place at identical time intervals. If it is necessary to carry out this operation three times per axial revolution, the peg 25 is extracted from the hole 23d and the pegs 25 are pressed into the holes 23a and 23b. The activation of the pump 11, in turn, takes place at identical time intervals.

Similarly, the dispensing frequency for the second dispenser system (aromatic substances) can be predetermined by pegs 24 being plugged into the holes 22a-d. The two time stipulations are independent of one another and always make it possible for the apparatus according to the invention to be adapted to the design of the air conditioning installation or to the size of the overall room volume to be air-conditioned.

Of course, the control of the dispensing times of the two dispenser systems by means of the control device 18, 20 may also take place electronically and be combined with the control of the dispensing quantities by means of the timers 16, 16′. In this case too, the quantities to be dispensed and the dispensing times of the two dispenser systems can be set independently of one another.

The apparatus according to the invention can be controlled and monitored via an operating panel. The operating panel (not illustrated) comprises an indicator, on which it can be seen whether the apparatus according to the invention is connected to the circuit, whether the apparatus according to the invention is functioning and whether the storage containers 3 for the aromatic substance and/or for the antibacterial active substance are full or empty. The indicators may be implemented by means of colored LEDs. Furthermore, an acoustic signal is emitted as soon as one of the storage containers 3 is empty. The apparatus according to the invention can be activated and deactivated by means of a switch.

Since air conditioning installations for buildings are often arranged at inaccessible locations, the operating panel can preferably be removed from the apparatus and, for example, by means of line connections or via a radio link, be used as a remote operating panel which is mounted at a more suitable location in the building.

FIG. 6 shows three different versions of an evaporator in differently dimensioned air conditioning installations. The evaporators illustrated consist of one, two or four heat exchanger plates 1. At least in the multiplate versions, a dispenser system for ejecting the antibacterial active substance fluid by means of a plurality of spray heads (not illustrated) is used.

As may be gathered from FIG. 6, the heat exchanger plates 1 are always implemented at an inclination to the direction of flow and, in the case of the multiplate systems, in an orientation angled with respect to one another.

Furthermore, in all the versions, a UV lamp may be used in order to irradiate the air stream with ultraviolet radiation. The sterilizing action of the UV light leads to a further reduction in the load caused by harmful microorganisms in the air-conditioned air stream. The UV lamp may likewise be operated by means of the switched operating voltage of the fan, so that it lights up only in the operating phase of the air conditioning installation.

FIG. 7 shows a perspective illustration of a UV lamp 30 of this type. The UV lamp 30 may, in general, be of any form of construction. The UV lamp illustrated in FIG. 7 has a cylindrical tube body 31, at the ends of which tube sockets 32 are mounted. One of the tube sockets 32 is provided with electrical contacts 33.

Located at the region of the tube body 31 are air guide elements which are designed here in the form of ducts 34 which extend around the tube body 31 in the circumferential direction. FIG. 8 shows one of these circumferential ducts 34 permeable to a UV light. The air stream falling onto the UV lamp 30 is illustrated by arrows 35. The circumferential duct 34 runs around the tube body 31 in a manner of a single screw flight. It has a U-shaped cross-sectional form which widens at its inlet region 34.1 by means of an outwardly shaped inlet lip. At the outlet region 34.2, the air flowing through the circumferential duct 34 leaves the circumferential duct 34 in the direction of the arrow 36, that is to say essentially in the same direction as that in which it flowed into the circumferential duct 34.

What is achieved by the circumferential ducts 34 is that the air flowing through the circumferential ducts 34 is kept in the region immediately adjacent to the UV 30 for a prolonged period of time, with the result that the irradiation efficiency and consequently the germicidal or antibacterial action of the UV light are markedly increased, as compared with a mere flow past of the air.

The circumferential ducts 34 do not have to run completely (360°) around the tube body 31, but instead, it is also possible for the circumferential ducts 34 to cover only a part circumference of the tube body 31. In place of circular circumferential ducts, for example, oval circumferential ducts 34 may also be used, this being advantageous particularly when a circumferential duct 34 is intended to run around a plurality of UV tubes 31 arranged next to one another or what are known as U-profile UV lamps (consisting in each case of two cylindrical tube bodies lying next to one another and connected to one another at one end by means of a bend). Furthermore, differently shaped air guide elements may also be used, which ensure a prolonged duration of irradiation of the air flowing past the UV lamp 30, and this can be implemented, in principle, in that the air stream is deflected out its direction of flow by means of the air guide elements and is lead along or adjacently to a light exit surface of the UV lamp 30 over a prolonged flow path.

For example, the UV lamp may also be arranged longitudinally to the air stream 35 and be provided with a sheath spaced apart from the tube body 31 and consisting of a material permeable to UV light, for example based on Teflon. The air stream 35 enters the sheath at one end of the latter and leaves the sheath at the opposite end. On the inner wall of the sheath are arranged air guide elements in the form of radially inwardly projecting stretched-out screw flights which ensure a turbulence of the air flowing through the sheath, in such a way that this air, on its path through the sheath, moves circularly around the UV lamp several times.

It is pointed out that the UV lamp 30 may also be used, without the disinfection apparatus according to the invention (FIG. 1 to 5), in air conditioning systems and their line systems, in particular in air conditioning installations.

1. An apparatus for the disinfection of an air conditioning installation of a stationary air conditioning system of a building or a room, the apparatus comprising:
an injection device for the accurate ejection of a defined quantity of an antibacterial active substance onto an evaporator of the air conditioning installation, and
a control device for controlling the ejection times of the injection device in the automated repetition mode.

2. The apparatus as claimed in claim 1, wherein
the air conditioning system is an installation with a plurality of ventilation ducts for the air conditioning of a room at a plurality of points and/or of a building having a plurality of ventilated rooms, and
the evaporator is an integral part of a central air conditioning installation of the air conditioning system for all the ventilation ducts which the air conditioning system comprises.

3. The apparatus as claimed in claim 1 or 2, wherein
the injection device comprises a reservoir for storing the antibacterial active substance, an injection pump activated electrically by the control device, and at least one nozzle head connected to an outlet of the injection pump via a pipeline.

4. The apparatus as claimed in claim 2, wherein or
the injection pump has a compressible volume filled with active substance and an actuating mechanism, for the abrupt compression of the volume.

5. The apparatus as claimed in claim 2, wherein
a nonreturn valve is arranged between the outlet of the injection pump and the nozzle 5 head.

6. The apparatus as claimed in claim 5, wherein
the nonreturn valve is provided with a prestessing means which has the effect that an opening of the valve in the throughflow direction takes place only when the prestress is exceeded.

7. The apparatus as claimed in claim 4, 5, or 6, wherein
the injection device is designed in such a way that an air-free ejection of the active substance at the nozzle head takes place.

8. The apparatus as claimed in claim 3, wherein
the nozzle head is mounted on the pipeline in an articulated manner.

9. The apparatus as claimed in claim 3, wherein
the nozzle head has a spray cone with an opening angle of between 135° and 170°.

10. The apparatus as claimed in claim 1, wherein
the control device for controlling the ejection times of the injection device allows a variable setting of the ejection times.

11. The apparatus as claimed in claim 1, wherein
the control device is designed to control the active substance quantity to be ejected.

12. The apparatus as claimed in claim 1, wherein
the air conditioning system comprises a control unit for controlling the air conditioning installation, and
the control device of the injection device is connected to a control unit of the air conditioning installation.

13. The apparatus as claimed in claim 1, wherein
the control device comprises an electric motor, a rotatable control disk driven by the electric motor, and at least one electrical switch which can be actuated by means of one or more actuating members mounted on the control disk and which is provided for switching a current for the injection pump of the injection device.

14. The apparatus as claimed in claim 3, wherein
the control device comprise an electrical circuit which activates the injection pump of the injection device at predeterminable times.

15. The apparatus as claimed in claim 1, wherein
an active substance concentrate is used as the active substance.

16. The apparatus as claimed in claim 3, wherein
the apparatus has a plurality of nozzle heads which are fed by the injection pump via respective pipelines.

17. The apparatus as claimed in claim 1, wherein the apparatus further comprises:
a metering device for the time-controllable dispensing of an aromatic substance, and
an absorbent uptake carrier which is provided in a duct of the air conditioning system and onto which the aromatic substance dispensed by the metering device is metered.

18. The apparatus as claimed in claim 17, wherein
the metering device is designed in the form of a further electromechanical injection device for ejecting the aromatic substance onto the absorbent uptake carrier.

19. The apparatus as claimed in claim 17 or 18, wherein
the control device is provided both for controlling the injection device for injecting the antibacterial active substance and for the time control of the metering device for metering the aromatic substance onto the absorbent uptake carrier.

20. The apparatus as claimed in claim 19, wherein
the control device is designed to make it possible to dispense antibacterial active substance and aromatic substance independently in terms of quantity.

21. The apparatus as claimed in claim 13, 17, or 18, wherein
the control device comprises a further switch which is provided for switching a current for the metering device, and
the rotatable control disk comprises, in addition to the actuating members for actuating the switch for switching the current for the injection pump of the injection device for the antibacterial active substance, further actuating members which are provided for actuating the further switch.

22. The apparatus as claimed in claim 17 or 18, wherein
the absorbent uptake carrier comprises a 15 fiber-containing and/or open-pore material.

23. The apparatus as claimed in claim 1, wherein
the control device of the apparatus comprises a remote monitoring and/or remote operating device, by means of which the apparatus can be monitored and/or operated by the user.

24. The apparatus as claimed in claim 1, wherein
the apparatus further comprises, UV lamp for irradiating the air stream in the air conditioning system.

25. The apparatus as claimed in claim 24, wherein
the UV lamp is provided with air guide elements which are designed in such a way that an air stream flowing past the UV lamp has at least partially a prolonged dwell time in the region of the UV lamp.

26. The apparatus as claimed in claim 25, wherein
the air guide elements are ducts which run along a curved surface of the UV lamp.

27. The apparatus as claimed in claim 26, wherein
the UV lamp has a cylindrical shape, and the ducts extend at least part-circularly over the circumference of the UV lamp.

28. A UV lamp, comprising the apparatus according to claim 25, 26, or 27.

29. A method for the disinfection of an air conditioning installation of a stationary air conditioning system of a building or room, comprising:
determining ejection times by means of a control device; and
at the ejection times, accurate pulsed injecting an antibacterial active substance onto an evaporator of the air conditioning installation by means of an electomechanical injection device.

30. The method as claimed in claim 29, further comprising
controlling the ejection times as a function of the operating state of the air conditioning installation.

31. The method as claimed in claim 29 or 30, wherein
the active substance is applied to the evaporator during the continuous operation of the air conditioning installation.

32. The method as claimed in claim 29 or 30, further comprising
time-controlled metering of an aromatic substance onto an absorbent uptake carrier, located in a duct of the air conditioning system, by means of a metering device.

33. The method as claimed in claim 32, wherein
the time control of the injection device for the injection of the antibacterial active substance and the time control of the metering device are carried out by means of the same control device.

34. The method as claimed in claim 29 or 30, further comprising irradiating
the air stream lead through the air conditioning system by means of a UV lamp.
